(19) United States
(12) Patent Application Publication
(10) Pub. No.: US 2019/0105969 A1
(43) Pub. Date: Apr. 11, 2019

(54) TRANSPORT REFRIGERATION UNIT

(71) Applicant: Carrier Corporation, Palm Beach Gardens, FL (US)

(72) Inventors: Robert A. Chopko, Baldwinsville, NY (US); Yu H. Chen, Manlius, NY (US); Greg Deldicque, Fayetteville, NY (US)

(21) Appl. No.: 16/089,743

(22) PCT Filed: Mar. 29, 2017
(86) PCT No.: PCT/US2017/024655

§ 371 Date: Sep. 28, 2018

Related U.S. Application Data
(60) Provisional application No. 62/315,350, filed on Mar. 30, 2016.

(51) Int. Cl. B60H 1/32; B60H 1/00; F25D 29/00

(52) U.S. Cl. CPC B60H 1/3232; B60H 1/00828; F25B 1/10; F25D 29/003; B60Y 2200/147; B60H 1/3226

(57) ABSTRACT

A transport refrigeration unit (26) includes a compressor (58) constructed and arranged to compress a refrigerant and a compressor motor (60) configured to drive the compressor (58). A condenser heat exchanger (64) of the unit is operatively coupled to the compressor (58), a condenser fan (66) is configured to provide air flow over the condenser heat exchanger (64), and a condenser fan motor (90) drives the condenser fan (66). An evaporator heat exchanger (76) of the unit is operatively coupled to the compressor (58), an evaporator fan (78) is configured to provide air flow over the evaporator heat exchanger (76), and an evaporator fan motor (98) drives the evaporator fan (78). A combustion engine (56) of the unit drives a generator (54) configured to provide electric power to the compressor motor (60). An energy storage device (52) of the unit is configured to provide electric power to the condenser and evaporator fan motors (90, 98).

### BACKGROUND

The present disclosure relates to transport refrigeration units and, more particularly, to all-electric transport refrigeration units.

Traditional refrigerated cargo trucks or refrigerated tractor trailers, such as those utilized to transport cargo via sea, rail, or road, is a truck, trailer or cargo container, generally defining a cargo compartment, and modified to include a refrigeration system located at one end of the truck, trailer, or cargo container. Refrigeration systems typically include a compressor, a condenser, an expansion valve, and an evaporator serially connected by refrigerant lines in a closed refrigerant circuit in accord with known refrigerant vapor compression cycles. A power unit, such as a combustion engine, drives the compressor of the refrigeration unit, and may be diesel powered, natural gas powered, or other type of engine. In many tractor trailer transport refrigeration systems, the compressor is driven by the engine shaft either through a belt drive or by a mechanical shaft-to-shaft link. In other systems, the engine of the refrigeration unit drives a generator that generates electrical power, which in-turn drives the compressor.

With current environmental trends, improvements in transport refrigeration units are desirable particularly toward aspects of environmental impact. With environmentally friendly refrigeration units, improvements in reliability, cost, and weight reduction are also desirable.

### SUMMARY

A transport refrigeration unit according to one, non-limiting, embodiment of the present disclosure includes a compressor constructed and arranged to compress a refrigerant; a compressor motor configured to drive the compressor; a condenser heat exchanger operatively coupled to the compressor; a condenser fan configured to provide air flow over the condenser heat exchanger; a condenser fan motor for driving the condenser fan; an evaporator heat exchanger operatively coupled to the compressor; an evaporator fan configured to provide air flow over the evaporator heat exchanger; an evaporator fan motor for driving the evaporator fan; a combustion engine; a generator mechanically driven by the combustion engine, and configured to provide electric power to the compressor motor; and

an energy storage device configured to provide electric power to the condenser and evaporator fan motors.

Additionally to the foregoing embodiment, the generator is configured to recharge the energy storage device.

In the alternative or additionally thereto, in the foregoing embodiment, the energy storage device is a battery.

In the alternative or additionally thereto, in the foregoing embodiment, the transport refrigeration unit includes a computer-based controller configured to initiate the recharge of the energy storage device during low compressor load.

In the alternative or additionally thereto, in the foregoing embodiment, the transport refrigeration unit includes a computer-based controller configured to control energy distribution such that the compressor motor, the condenser fan motor and the evaporator fan motor may individually receive power from the energy storage device or the generator as dictated by the computer based controller.

In the alternative or additionally thereto, in the foregoing embodiment, the computer-based controller is configured to execute an algorithm for optimizing performance of energy distribution between the generator and the energy storage device.

In the alternative or additionally thereto, in the foregoing embodiment, the refrigerant is a natural refrigerant.

In the alternative or additionally thereto, in the foregoing embodiment, the natural refrigerant is carbon dioxide.

In the alternative or additionally thereto, in the foregoing embodiment, the battery has a voltage potential within a range of about 48V to 220V.

In the alternative or additionally thereto, in the foregoing embodiment, the transport refrigeration unit utilizes less than 19 kW.

In the alternative or additionally thereto, in the foregoing embodiment, the battery is a lithium ion battery.

In the alternative or additionally thereto, in the foregoing embodiment, the battery is an ion phosphate battery.

A method of operating a transport refrigeration unit according to another, non-limiting, embodiment includes operating a generator to produce electrical power; providing electrical power from the generator to a compressor motor; and providing electrical power from an energy storage device to an evaporator fan motor and a condenser fan motor.

Additionally to the foregoing embodiment, the method includes recharging the energy storage device via the generator during low compressor load conditions.

In the alternative or additionally thereto, in the foregoing embodiment, the method includes switching power from the generator to the energy storage device for running the compressor motor when dictated by a computer-based controller.

In the alternative or additionally thereto, in the foregoing embodiment, the method includes switching power from the energy storage device to the generator for running at least one of the evaporator fan motor and the condenser fan motor when dictated by the computer-based controller.

In the alternative or additionally thereto, in the foregoing embodiment, the computer-based controller executes an algorithm to optimize energy distribution.

In the alternative or additionally thereto, in the foregoing embodiment, the energy storage device is a battery having a voltage potential of at least 48V.

In the alternative or additionally thereto, in the foregoing embodiment, the energy storage device is a battery having a voltage potential of at least 220V.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of a tractor trailer system having a transport refrigeration unit as one, non-limiting, embodiment of the present disclosure;

FIG. 2 is a schematic of the transport refrigeration unit;

FIG. 3 is a block diagram of a multiple energy source of the transport refrigeration unit illustrating a power distribution scheme; and

FIG. 4 is a flow chart illustrating a method of operating the transport refrigeration unit.

### DETAILED DESCRIPTION

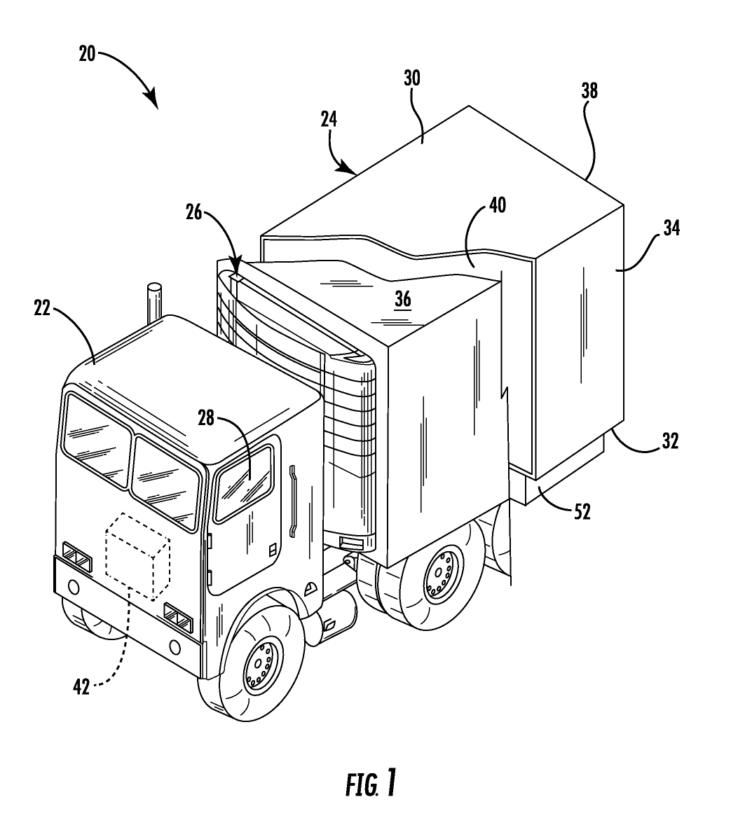

Referring to FIG. 1, a tractor trailer system 20 of the present disclosure is illustrated. The tractor trailer system 20 may include a tractor or truck 22, a trailer 24 and a transport refrigeration unit 26. The tractor 22 may include an operator's compartment or cab 28 and a combustion engine 42 which is part of the powertrain or drive system of the tractor 22. The trailer 24 may be coupled to the tractor 22 and is thus pulled or propelled to desired destinations. The trailer may include a top wall 30, a bottom wall 32 opposed to and space from the top wall 30, two side walls 34 space from and opposed to one-another, and opposing front and rear walls 36, 38 with the front wall 36 being closest to the tractor 22. The trailer 24 may further include doors (not shown) at the rear wall 38, or any other wall. The walls 30, 32, 34, 36, 38 together define the boundaries of a cargo compartment 40. It is further contemplated and understood that the cargo compartment may also be divided into two or more smaller compartments for different temperature cargo requirements.

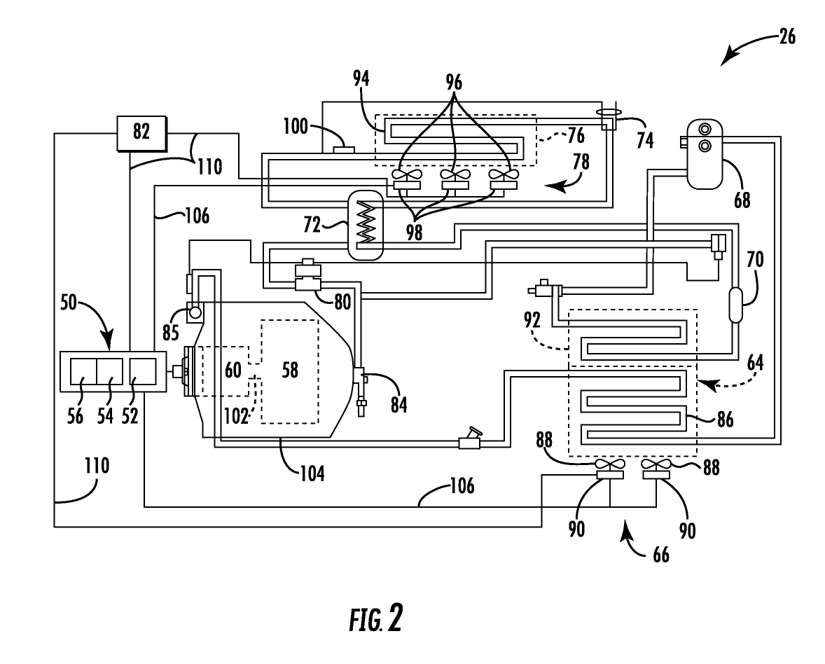

Referring to FIGS. 1 and 2, the trailer 24 is generally constructed to store a cargo (not shown) in the compartment 40. The transport refrigeration unit 26 is generally integrated into the trailer 24 and may be mounted to the front wall 36. The cargo is maintained at a desired temperature by cooling of the compartment 40 via the refrigeration unit 26 that circulates airflow into and through the cargo compartment 40 of the trailer 24. It is further contemplated and understood that the refrigeration unit 26 may be applied to any transport container and not necessarily those used in tractor trailer systems. Furthermore, the transport container may be a part of the trailer 24 and constructed to be removed from a framework and wheels (not shown) of the trailer 24 for alternative shipping means (e.g., marine, rail, flight, and others).

The components of the transport refrigeration unit 26 may include a compressor 58, an electric compressor motor 60, a condenser 64 that may be air cooled, a condenser fan assembly 66, a receiver 68, a filter dryer 70, a heat exchanger 72, a thermostatic expansion valve 74, an evaporator 76, an evaporator fan assembly 78, a suction modulation valve 80, and a controller 82 that may include a computer-based processor (e.g., microprocessor). Operation of the transport refrigeration unit 26 may best be understood by starting at the compressor 58, where the suction gas (i.e., natural refrigerant) enters the compressor at a suction port 84 and is compressed to a higher temperature and pressure. The refrigerant gas is emitted from the compressor 58 at an outlet port 85 and may then flow into tube(s) 86 of the condenser 64.

Air flowing across a plurality of condenser coil fins (not shown) and the tubes 86, cools the gas to its saturation temperature. The air flow across the condenser 64 may be facilitated by one or more fans 88 of the condenser fan assembly 66. The condenser fans 88 may be driven by respective condenser fan motors 90 of the fan assembly 66 that may be electric.

By removing latent heat, the gas within the tubes 86 condenses to a high pressure and high temperature liquid and flows to the receiver 68 that provides storage for excess liquid refrigerant during low temperature operation. From the receiver 68, the liquid refrigerant may pass through a subcooler heat exchanger 92 of the condenser 64, through the filter-dryer 70 that keeps the refrigerant clean and dry, then to the heat exchanger 72 that increases the refrigerant subcooling, and finally to the thermostatic expansion valve 74.

As the liquid refrigerant passes through the orifices of the expansion valve 74, some of the liquid vaporizes into a gas (i.e., flash gas). Return air from the refrigerated space (i.e., cargo compartment 40) flows over the heat transfer surface of the evaporator 76. As the refrigerant flows through a plurality of tubes 94 of the evaporator 76, the remaining liquid refrigerant absorbs heat from the return air, and in so doing, is vaporized.

The evaporator fan assembly 78 includes one or more evaporator fans 96 that may be driven by respective fan motors 98 that may be electric. The air flow across the evaporator 76 is facilitated by the evaporator fans 96. From the evaporator 76, the refrigerant, in vapor form, may then flow through the suction modulation valve 80, and back to the compressor 58. A thermostatic expansion valve bulb sensor 100 may be located proximate to an outlet of the evaporator tube 94. The bulb sensor 100 is intended to control the thermostatic expansion valve 74, thereby controlling refrigerant superheat at an outlet of the evaporator tube 94. It is further contemplated and understood that the above generally describes a single stage vapor compression system that may be used for natural refrigerants such as propane and ammonia. Other refrigerant systems may also be applied that use carbon dioxide (CO2) refrigerant, and that may be a two-stage vapor compression system.

A bypass valve (not shown) may facilitate the flash gas of the refrigerant to bypass the evaporator 76. This will allow the evaporator coil to be filled with liquid and completely ‘wetted’ to improve heat transfer efficiency. With CO2 refrigerant, this bypass flash gas may be re-introduced into a mid-stage of a two-stage compressor.

The compressor 58 and the compressor motor 60 may be linked via an interconnecting drive shaft 102. The compressor 58, the compressor motor 60 and the drive shaft 102 may all be sealed within a common housing 104. In some embodiments, the compressor motor 60 may be positioned outside of the compressor housing 104, and therefore the interconnecting drive shaft 102 may pass through a shaft seal located in the compressor housing. The compressor 58 may be a single compressor. The single compressor may be a two-stage compressor, a scroll-type compressor or other compressors adapted to compress natural refrigerants. The natural refrigerant may be CO2, propane, ammonia, or any other natural refrigerant that may include a global-warming potential (GWP) of about one (1).

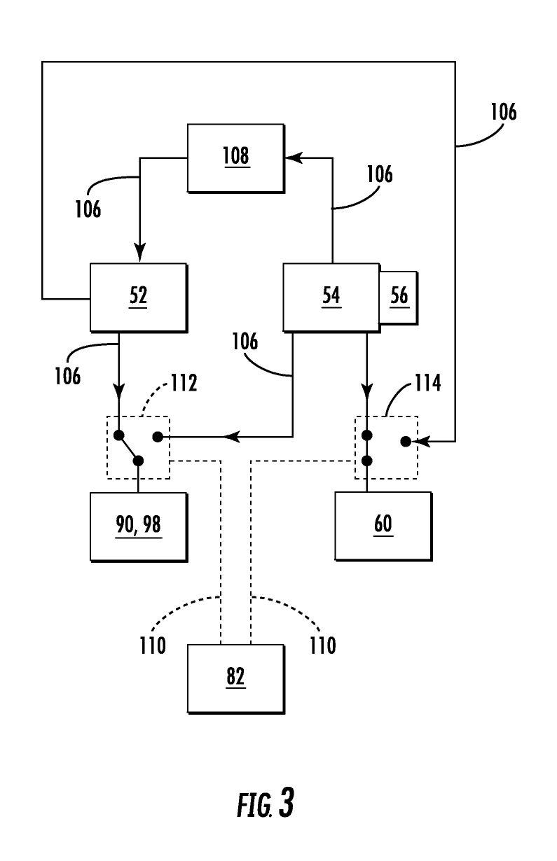

Referring to FIGS. 2 and 3, the transport refrigeration unit 26 further includes a multiple energy source 50 configured to selectively power the compressor motor 60, the condenser fan motors 90, the evaporator fan motors 98, the controller 82, and other components 99 (see FIG. 3), which may include various solenoids and/or sensors, via, for example, electrical conductors 106. The multiple energy source 50 may include an energy storage device 52, and a generator 54 mechanically driven by a combustion engine 56 that may be part of, and dedicated to, the transport refrigeration unit 26. The energy storage device 52 may be at least one battery. In one embodiment, the battery 52 may be configured to provide direct current (DC) electric power to one or both of the evaporator and condenser fan motors 98, 90, while the generator 54 provides electrical power to the compressor motor 60. The electric power provided to the compressor motor 60 may be alternating current (AC) or DC with the associated configuration of inverters and/or converters (not shown) typically known in the art. Accordingly, the compressor motor 60 may be an AC motor or a DC motor. The fan motors 90, 98 may be DC motors corresponding to the DC power provided by the battery 52. In one embodiment, the energy storage device 52 may be secured to the underside of the bottom wall 32 of the trailer 24 (see FIG. 1). It is further contemplated and understood that other examples of the energy storage device 52 may include fuel cells, and other devices capable of storing and outputting DC power.

Referring to FIG. 3, the transport refrigeration unit 26 may further include a battery charger 108 that may be powered by the generator 54 during part-load operating conditions of the transport refrigeration unit 26 (i.e., partial compressor load conditions). The battery charger 108 may be controlled by the controller 82 and is configured to charge the batteries 52 when needed and during ideal operating conditions. By charging the batteries 52 during reduced compressor load conditions, the size and weight of the generator 54 and driving engine 56 may be minimized.

The controller 82 through a series of data and command signals over various pathways 110 may, for example, control the electric motors 60, 90, 98 as dictated by the cooling needs of the refrigeration unit 26. The transport refrigeration unit 26 may include a DC architecture without any of the components requiring AC power to operate (i.e., the motors 60, 90, 98 may be DC motors). The batteries 52 may be dedicated to operate the fans 90, 98 and the generator may operate the compressor motor 60. In this example, the batteries 52 may have a voltage potential of about forty-eight volts (48V), and the compressor motor 60 may operate at a voltage that is considerably higher than the battery voltage potential, and that may be about equal to or greater than two-hundred and twenty volts (220V).

In another embodiment, the transport refrigeration unit 26 may include at least one load switch 112 for switching between the battery 52 and generator 54 when providing electric power to any one or more of the fans 90, 98. Similarly, the transport refrigeration unit 26 may include at least one load switch 114 for switching between the battery 52 and generator 54 when providing electric power to the compressor motor 60. The controller 82 may generally control operation of the load switches 112, 114 over communication pathways 110. For example, during low energy battery conditions and/or low compressor load conditions, the controller may direct load switch 112 to close a circuit that arranges the generator 54 to provide DC power to one or more of the fans 90, 98. Similarly and during, for example, low engine fuel conditions, the controller may direct load switch 114 to close a circuit that arranges the batteries 52 to provide, for example, DC power to the compressor motor 60. It is further contemplated and understood that in this embodiment, the voltage potential of the batteries may be greater than about two-hundred and twenty volts (220V) to efficiently operate a relatively light weight compressor motor.

In order to meet government regulatory requirements, it is desirable to operate the transport refrigeration unit 26 with a natural refrigerant and utilizing less than about nineteen kilowatts (19 kW) of power. In one example, the generator 54 output may be about seventeen kilowatts (17 kW) with the battery charger 108 expending about 0.3 kW and the compressor motor 60 expending about 14.4 kW. The batteries 52 may produce an output of about 3 kW with the evaporator fan motor 98 expending about 1 kW and the condenser fan motor 90 expending about 2 kW of power. The batteries 52 may be long life batteries that may be of a lithium ion type, an ion phosphate type, or other types.

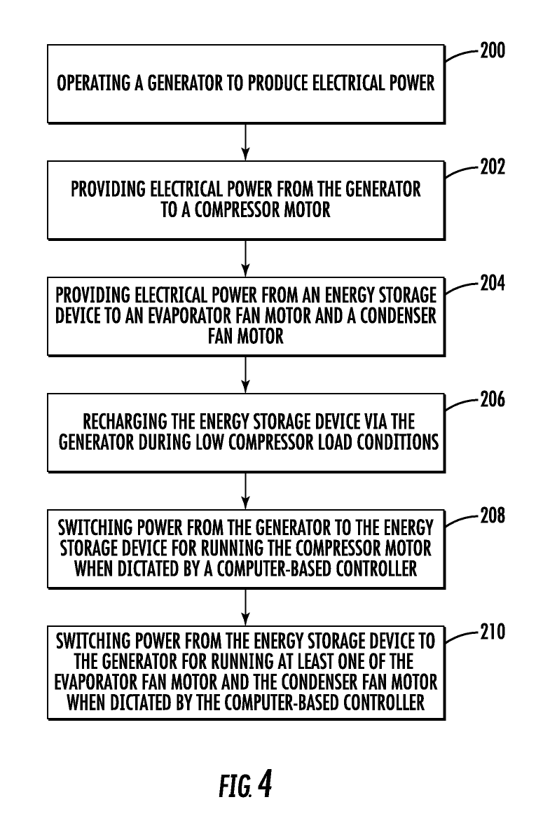

Referring to FIG. 4, a method of operating the transport refrigeration unit 26 is illustrated wherein a first block 200 includes operating the generator 54 to produce electric power. Block 202 entails providing electrical power from the generator 54 to the compressor motor 60. Another block 204 includes providing electrical power from the energy storage device 52 to the evaporator fan motor 98 and/or the condenser fan motor 90. A block 206 includes recharging the energy storage device 52 via the generator 54 and the battery charger 108 during low compressor load conditions. Block 208 entails switching power from the generator 54 to the energy storage device 52 for running the compressor motor 60 when dictated by the computer-based controller 82. Similarly, block 210 entails switching power from the energy storage device 52 to the generator 54 for running at least one of the evaporator fan motor 98 and the condenser fan motor 90 when dictated by the computer-based controller 82. It is further understood and contemplated that the computer-based controller 82 may execute an algorithm to optimize energy production between the batteries 52 and the generator 54 and optimize energy distribution between the loads (e.g., fan motors 90, 98 and compressor motor 60).

Benefits of the present disclosure when compared to more traditional systems include lower fuel consumption, and a refrigeration unit that may emit less noise and may be lighter in weight. Yet further, the present disclosure includes an energy storage device that is conveniently and efficiently recharged to meet the power demands of the refrigeration unit while meeting combustion engine power and emission requirements that may be enforced by regulatory/government agencies.

While the present disclosure is described with reference to the figures, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A transport refrigeration unit comprising:
a compressor constructed and arranged to compress a refrigerant;
a compressor motor configured to drive the compressor;
a condenser heat exchanger operatively coupled to the compressor;
a condenser fan configured to provide air flow over the condenser heat exchanger;
a condenser fan motor for driving the condenser fan;
an evaporator heat exchanger operatively coupled to the compressor;
an evaporator fan configured to provide air flow over the evaporator heat exchanger;
an evaporator fan motor for driving the evaporator fan;
a combustion engine;
a generator mechanically driven by the combustion engine, and configured to provide electric power to the compressor motor; and
an energy storage device configured to provide electric power to the condenser and evaporator fan motors.

2. The transport refrigeration unit set forth in claim 1, wherein the generator is configured to recharge the energy storage device.

3. The transport refrigeration unit set forth in claim 2, wherein the energy storage device is a battery.

4. The transport refrigeration unit set forth in claim 2 further comprising:
a computer-based controller configured to initiate the recharge of the energy storage device during low compressor load.

5. The transport refrigeration unit set forth in claim 1 further comprising:
a computer-based controller configured to control energy distribution such that the compressor motor, the condenser fan motor and the evaporator fan motor may individually receive power from the energy storage device or the generator as dictated by the computer based controller.

6. The transport refrigeration unit set forth in claim 5, wherein the computer-based controller is configured to execute an algorithm for optimizing performance of energy distribution between the generator and the energy storage device.

7. The transport refrigeration unit set forth in claim 1, wherein the refrigerant is a natural refrigerant.

8. The transport refrigeration unit set forth in claim 7, wherein the natural refrigerant is carbon dioxide.

9. The transport refrigeration unit set forth in claim 3, wherein the battery has a voltage potential within a range of about 48V to 220V.

10. The transport refrigeration unit set forth in claim 9, wherein the transport refrigeration unit utilizes less than 19 kW.

11. The transport refrigeration unit set forth in claim 3, wherein the battery is a lithium ion battery.

12. The transport refrigeration unit set forth in claim 3, wherein the battery is an ion phosphate battery.

13. A method of operating a transport refrigeration unit comprising:
operating a generator to produce electrical power;
providing electrical power from the generator to a compressor motor; and
providing electrical power from an energy storage device to an evaporator fan motor and a condenser fan motor.

14. The method set forth in claim 13 further comprising:
recharging the energy storage device via the generator during low compressor load conditions.

15. The method set forth in claim 14 further comprising:
switching power from the generator to the energy storage device for running the compressor motor when dictated by a computer-based controller.

16. The method set forth in claim 15 further comprising:
switching power from the energy storage device to the generator for running at least one of the evaporator fan motor and the condenser fan motor when dictated by the computer-based controller.

17. The method set forth in claim 16, wherein the computer-based controller executes an algorithm to optimize energy distribution.

18. The method set forth in claim 13, wherein the energy storage device is a battery having a voltage potential of at least 48V.

19. The method set forth in claim 15, wherein the energy storage device is a battery having a voltage potential of at least 220V.
